(19) United States
(12) Patent Application Publication
(10) Pub. No.: US 2026/0074721 A1
(43) Pub. Date: Mar. 12, 2026

(54) HIGH FREQUENCY MODULE AND COMMUNICATION APPARATUS

(71) Applicant: Murata Manufacturing Co., Ltd., Nagaokakyo-shi (JP)

(72) Inventors: Mizuho ISHIKAWA, Nagaokakyo-shi (JP); Yusaku KOMAMURA, Nagaokakyo-shi (JP)

(21) Appl. No.: 19/308,428

(22) Filed: Aug. 25, 2025

(30) Foreign Application Priority Data
Sep. 6, 2024 (JP) 2024-153745

(51) Int. Cl. H04B 1/04

(52) U.S. Cl. CPC H04B 1/0458; H04B 2001/0408

(57) ABSTRACT

A high frequency module includes a first drive stage amplification unit, a second drive stage amplification unit, a final stage amplification unit, a first matching circuit, and a second matching circuit. The first drive stage amplification unit is connected to a first input unit. The second drive stage amplification unit is connected to a second input unit. The final stage amplification unit is connected to output units. The first matching circuit is connected between the first drive stage amplification unit and the final stage amplification unit, and has a first pass band including a first communication band and a first attenuation band including a second communication band. The second matching circuit is connected between the second drive stage amplification unit and the final stage amplification unit, and has a second pass band including the second communication band and a second attenuation band including the first communication band.

### CROSS REFERENCE TO RELATED APPLICATION

This application claims priority from Japanese Patent Application No. 2024-153745, filed on Sep. 6, 2024. The content of this applications is incorporated herein by reference in its entirety.

### BACKGROUND OF THE DISCLOSURE

### 1. Field of the Disclosure

The present disclosure generally relates to a high frequency module and a communication apparatus, or more specifically to a high frequency module including multiple power amplifiers and a communication apparatus including the high frequency module.

### 2. Description of the Related Art

A high frequency module described in International Publication No. WO 2022/118891 includes a first power amplifier that amplifies a transmission signal in a first frequency band, and a second power amplifier that amplifies a transmission signal in a second frequency band. The first power amplifier includes a first drive stage amplification unit and a first final stage amplification unit. The second power amplifier includes a second drive stage amplification unit and a second final stage amplification unit.

### BRIEF SUMMARY OF THE DISCLOSURE

The high frequency module described in International Publication No. WO 2022/118891 includes the drive stage amplification unit and the final stage amplification unit for each frequency band. In particular, the final stage amplification unit that generates a large power amplification signal is large in size, and therefore has a problem of an increase in size of the high frequency module. Meanwhile, in the case of providing the multiple power amplifiers, an unnecessary wave may leak out between the power amplifiers in some cases.

In view of the aforementioned problems, a possible benefit of the present disclosure is to provide a high frequency module and a communication apparatus, which are capable of suppressing leakage of unnecessary waves between power amplifiers and of downsizing.

A high frequency module according to an aspect of the present disclosure includes a first input unit, a second input unit, a first output unit, a first drive stage amplification unit, a second drive stage amplification unit, a final stage amplification unit, a first matching circuit, and a second matching circuit. A first transmission signal in a first communication band is inputted to the first input unit. A second transmission signal in a second communication band different from the first communication band is inputted to the second input unit. The first drive stage amplification unit is connected to a subsequent stage of the first input unit. The second drive stage amplification unit is connected to a subsequent stage of the second input unit. The final stage amplification unit is connected to a precedent stage of the first output unit. The first matching circuit is a matching circuit of a filter type which is connected between the first drive stage amplification unit and the final stage amplification unit, and has a first pass band including the first communication band and a first attenuation band including the second communication band. The second matching circuit is a matching circuit of a filter type which is connected between the second drive stage amplification unit and the final stage amplification unit, and has a second pass band including the second communication band and a second attenuation band including the first communication band.

A communication apparatus according to an aspect of the present disclosure includes the high frequency module and a signal processing circuit. The signal processing circuit is connected to the high frequency module and performs signal processing of a high frequency signal.

The high frequency module and the communication apparatus according to the present disclosure have benefits in enabling suppression of leakage of unnecessary waves between power amplifiers and in downsizing.

### BRIEF DESCRIPTION OF THE SEVERAL VIEWS OF THE DRAWINGS

FIG. 1 is a block diagram of a high frequency module and a communication apparatus according to an embodiment;

FIG. 2 is a block diagram of a multiband coupler in the above-mentioned high frequency module; and

FIG. 3 is a block diagram of a high frequency module and a communication apparatus according to a modified example of the embodiment.

### DETAILED DESCRIPTION OF THE DISCLOSURE

### Embodiment

A high frequency module 1 and a communication apparatus 200 according to an embodiment will be described in detail with reference to the drawings.

### (1) Outline

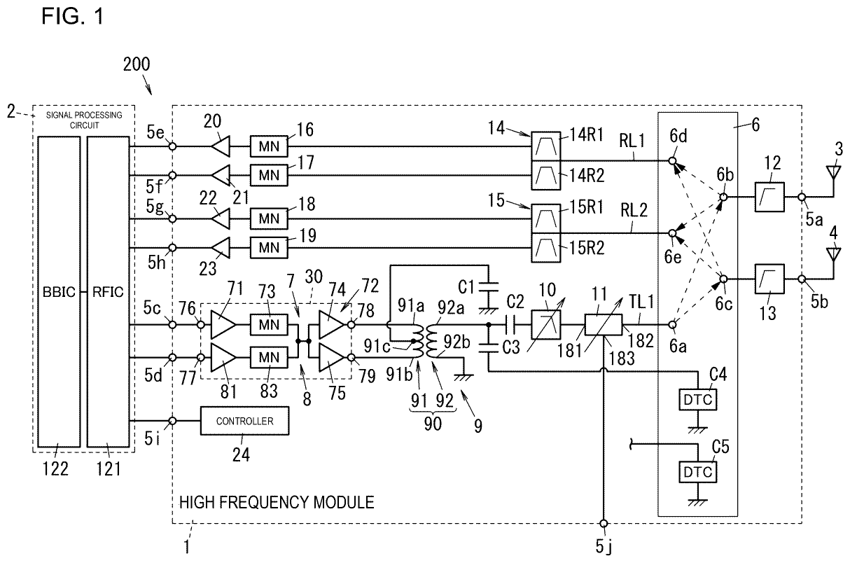

As shown in FIG. 1, the high frequency module 1 according to the embodiment includes a first input unit 76, a second input unit 77, first output units 78 and 79, a first drive stage amplification unit 71, a second drive stage amplification unit 81, a final stage amplification unit 72, a first matching circuit 73, and a second matching circuit 83. A first transmission signal in a first communication band is inputted to the first input unit 76. A second transmission signal in a second communication band different from the first communication band is inputted to the second input unit 77. The first drive stage amplification unit 71 is connected to a subsequent stage of the first input unit 76. The second drive stage amplification unit 81 is connected to a subsequent stage of the second input unit 77. The final stage amplification unit 72 is connected to a precedent stage of the first output units 78 and 79. The first matching circuit 73 is a matching circuit of a filter type which is connected between the first drive stage amplification unit 71 and the final stage amplification unit 72, and has a first pass band including the first communication band and a first attenuation band including the second communication band. The second matching circuit 83 is a matching circuit of a filter type which is connected between the second drive stage amplification unit 81 and the final stage amplification unit 72, and has a second pass band including the second communication band and a second attenuation band including the first communication band.

According to this configuration, the single final stage amplification unit 72 doubles as the final stage amplification unit for the first communication band and the final stage amplification unit for the second communication band which account for high occupancy rates, thereby enabling downsizing of the high frequency module 1.

In the meantime, the first matching circuit 73 of the filter type is connected between the first drive stage amplification unit 71 and the final stage amplification unit 72, while the second matching circuit 83 of the filter type is connected between the second drive stage amplification unit 81 and the final stage amplification unit 72. Accordingly, a signal component in the same frequency band as the second communication band out of an output signal from the first drive stage amplification unit 71 can be kept from leaking out to the second drive stage amplification unit 81 side as an unnecessary wave, or a signal component in the same frequency band as the first communication band out of an output signal from the second drive stage amplification unit 81 can be kept from leaking out to the first drive stage amplification unit 71 side as an unnecessary wave. As a consequence, it is possible to suppress leakage of unnecessary waves between power amplifiers 7 and 8.

### (2) Configuration of Communication Apparatus

As shown in FIG. 1, the communication apparatus 200 is a communication apparatus that includes the high frequency module 1. The communication apparatus 200 is a portable terminal (such as a smartphone), for example. However, the communication apparatus 200 is not limited to the portable terminal but may be a wearable terminal (such as a smartwatch), for instance. The high frequency module 1 is a module compatible with the fourth generation mobile communication systems (4G) standards and the fifth generation mobile communication systems (5G) standards, for example. The 4G standards include Third Generation Partnership Project (3GPP, registered trademark) or Long Term Evolution (LTE, registered trademark), for example. The 5G standards include 5G New Radio (NR), for example.

The communication apparatus 200 includes a signal processing circuit 2, and antennas 3 and 4 besides the high frequency module 1.

The high frequency module 1 is configured to amplify a transmission signal (a high frequency signal) outputted from the signal processing circuit 2, and to transmit the signal from the antenna 3 or 4. Moreover, the high frequency module 1 is configured to amplify a reception signal (a high frequency signal) received by the antenna 3 or 4 and to output the signal to the signal processing circuit 2. The high frequency module 1 is controlled by the signal processing circuit 2, for example.

The signal processing circuit 2 is connected to the high frequency module 1 and performs signal processing of the high frequency signals. To be more precise, the signal processing circuit 2 is configured to perform signal processing of the transmission signal to be outputted to the high frequency module 1. Meanwhile, the signal processing circuit 2 is configured to perform signal processing of the reception signal outputted from the high frequency module 1. The signal processing circuit 2 includes a radio frequency (RF) signal processing circuit 121 and a baseband signal processing circuit 122.

The RF signal processing circuit 121 is a radio frequency integrated circuit (RFIC), for example, which performs the signal processing of the high frequency signals (the transmission signal and the reception signal). The RF signal processing circuit 121 performs the signal processing such as upconversion of the transmission signal outputted from the baseband signal processing circuit 122, and outputs the signal to the high frequency module 1. Meanwhile, the RF signal processing circuit 121 performs the signal processing such as downconversion of the reception signal outputted from the high frequency module 1, and outputs the signal to the baseband signal processing circuit 122.

The baseband signal processing circuit 122 is a baseband integrated circuit (BBIC), for example. The baseband signal processing circuit 122 generates the transmission signal from baseband signals (a sound signal and an image signal, for example) inputted from outside, and outputs the generated transmission signal to the RF signal processing circuit 121. Meanwhile, the baseband signal processing circuit 122 outputs the reception signal to the outside, the reception signal being outputted from the RF signal processing circuit 121. This output signal (the reception signal) can be used as an image signal for image display or as a sound signal for a call, for instance.

### (3) Configuration of High Frequency Module 1

The high frequency module 1 transmits the first transmission signal in the first communication band and the second transmission signal in the second communication band, and receives a first reception signal in the first communication band and a second reception signal in the second communication band. The first communication band and the second communication band are communication bands that are different from each other. To be more precise, the second communication band is a communication band in a frequency band higher than the first communication band. The first communication band is n77, for example. The second communication band is n79, for example.

As shown in FIG. 1, the high frequency module 1 includes multiple external terminals 5a to 5j, an antenna switch 6, a first power amplifier 7, a second power amplifier 8, an output matching circuit 9, a variable low pass filter 10, a multiband coupler 11, high pass filters 12 and 13, diplexers 14 and 15, matching circuits 16 to 19, low noise amplifiers 20 to 23, and a controller 24. Here, the controller 24 may be separated into a transmission controller and a reception controller depending on functions thereof.

### (3.1) External Terminals

The external terminal 5a is a first antenna terminal connected to the first antenna 3. The external terminal 5b is a second antenna terminal connected to the second antenna 4. The external terminal 5c is an input terminal which is connected to an output unit of the signal processing circuit 2, and to which the first transmission signal in the first communication band that is outputted from the output unit of the signal processing circuit 2 is inputted. The external terminal 5d is an input terminal which is connected to the output unit of the signal processing circuit 2, and to which the second transmission signal in the second communication band that is outputted from the output unit of the signal processing circuit 2 is inputted. Each of the external terminals 5e and 5g is an output terminal connected to an input unit of the signal processing circuit 2, which outputs the first reception signal in the first communication band processed by the high frequency module 1 to the input unit of the signal processing circuit 2. Each of the external terminals 5f and 5h is an output terminal connected to the input unit of the signal processing circuit 2, which outputs the second reception signal in the second communication band processed by the high frequency module 1 to the input unit of the signal processing circuit 2. The external terminal 5i is an input unit connected to a signal output unit of the signal processing circuit 2 for inputting a control signal for controlling the controller 24 from the signal processing circuit 2. The external terminal 5j is an external terminal for outputting a detected signal by the multiband coupler 11 to outside.

### (3.2) Antenna Switch

The antenna switch 6 is a switch for selecting an antenna to use from the antennas 3 and 4. To be more precise, at the time of transmission, the antenna switch 6 selects one or more (one, for instance) from the antennas 3 and 4 as a connection destination of a transmission line TL1, and connects the selected antenna to the transmission line TL1. Meanwhile, at the time of reception, the antenna switch 6 selects one or more antennas from the antennas 3 and 4, then selects a connection destination of the selected antenna or antennas from two reception lines RL1 and RL2, and connects the selected antenna to the selected reception line. The antenna switch 6 is controlled by a control signal from the controller 24. The antenna switch 6 is a switch integrated circuit (IC), for example.

The antenna switch 6 includes terminals 6a to 6e. The terminal 6a is connected to the transmission line TL1. The transmission line TL1 connects between the terminal 6a and an output unit of the variable low pass filter 10. The terminal 6b is connected to the external terminal 5a with the high pass filter 12 interposed therebetween. The terminal 6c is connected to the external terminal 5b with the high pass filter 13 interposed therebetween. That is to say, the antenna switch 6 is connected to a subsequent stage of the variable low pass filter 10 and to the external terminals 5a and 5b. The terminal 6d is connected to the first reception line RL1. The first reception line RL1 connects between the terminal 6d and an input unit of the diplexer 14. The terminal 6e is connected to the second reception line RL2. The second reception line RL2 connects between the terminal 6e and an input unit of the diplexer 15. At the time of transmission, the terminal 6a is selectively connected to one of the two terminals 6b and 6c. At the time of reception, the respective terminals 6b and 6c are selectively connected to mutually different terminals out of the two terminals 6d and 6e.

The antenna switch 6 is connected to the subsequent stage of the variable low pass filter 10. Here, the state of being “connected to the subsequent stage of the variable low pass filter 10” includes a case of being indirectly connected to the variable low pass filter 10 with an electronic component (such as the multiband coupler 11) interposed therebetween and a case of being directly connected to the variable low pass filter 10 without an electronic component interposed therebetween. In the present embodiment, the antenna switch 6 is connected to the variable low pass filter 10 with the multiband coupler 11 interposed therebetween.

An after-mentioned variable capacitor C4 of the output matching circuit 9 and an after-mentioned variable capacitor C5 of the variable low pass filter 10 are disposed in the antenna switch 6. That is to say, the variable capacitors C4 and C5 are formed integrally with the antenna switch 6.

### (3.3) First Power Amplifier and Second Power Amplifier

The first power amplifier 7 is an amplification unit that amplifies the first transmission signal in the first communication band. The first power amplifier 7 is connected between the external terminal 5c and the output matching circuit 9. The first power amplifier 7 is a multistage (two in the example of FIG. 1) amplification unit. The first power amplifier 7 includes the first drive stage amplification unit 71, the final stage amplification unit 72, the first matching circuit 73, the first input unit 76, the second input unit 77, and the output units 78 and 79 (the first output units).

The first input unit 76 is connected to the external terminal 5c. The second input unit 77 is connected to the external terminal 5d. The output unit 78 is connected to a first end 91a of an after-mentioned balanced side coil 91 of a transformer 90. The output unit 79 is connected to a second end 91b of the balanced side coil 91.

The first drive stage amplification unit 71 is connected to the subsequent stage of the first input unit 76. The first drive stage amplification unit 71 includes an input unit and an output unit. The input unit of the first drive stage amplification unit 71 is connected to the first input unit 76. The output unit of the first drive stage amplification unit 71 is connected to an input unit of the final stage amplification unit 72 (that is to say, an input unit of an after-mentioned first amplification unit 74 and an input unit of an after-mentioned second amplification unit 75) with the first matching circuit 73 interposed therebetween. The first drive stage amplification unit 71 amplifies the signal (the first transmission signal) inputted to the aforementioned input unit at a predetermined amplification factor, and outputs the amplified signal from the aforementioned output unit.

The final stage amplification unit 72 is connected to the precedent stage of the output units 78 and 79. The final stage amplification unit 72 further amplifies the signal that is amplified by the first drive stage amplification unit 71. The final stage amplification unit 72 includes the first amplification unit 74 and the second amplification unit 75. The first amplification unit 74 includes the input unit and an output unit. The second amplification unit includes the input unit and an output unit. The input unit of the first amplification unit 74 and the input unit of the second amplification unit 75 are connected to each other, and are connected to the output unit of the first drive stage amplification unit 71 with the first matching circuit 73 interposed therebetween. The output unit of the first amplification unit 74 is connected to the output unit 78. That is to say, the output unit of the first amplification unit 74 is connected to the first end 91a of the balanced side coil 91 with the output unit 78 interposed therebetween. The output unit of the second amplification unit 75 is connected to the output unit 79. That is to say, the output unit of the second amplification unit 75 is connected to the second end 91b of the balanced side coil 91 with the output unit 79 interposed therebetween. The first amplification unit 74 amplifies the signal inputted to the input unit of the first amplification unit 74 at a predetermined amplification factor, and outputs the amplified signal from the output unit of the first amplification unit 74. The second amplification unit 75 amplifies the signal inputted to the input unit of the second amplification unit at a predetermined amplification factor, and outputs the amplified signal from the output unit of the second amplification unit 75.

The first matching circuit 73 is a matching circuit of a low pass filter type (that is to say, a filter type), for example. The first matching circuit 73 is connected between the first drive stage amplification unit 71 and the final stage amplification unit 72, and achieves impedance matching between the first drive stage amplification unit 71 and the final stage amplification unit 72.

In the meantime, the first matching circuit 73 is configured to function as a low pass filter, for example. To be more precise, the first matching circuit 73 functions as a filter that has a first pass band including the first communication band (such as n77), and a first attenuation band including the second communication band (such as n79). The first matching circuit 73 includes an input unit and an output unit. The input unit of the first matching circuit 73 is connected to the output unit of the first drive stage amplification unit 71. The output unit of the first matching circuit 73 is connected to the input unit of the final stage amplification unit 72 (the respective input units of the first amplification unit 74 and the second amplification unit 75). The first matching circuit 73 allows passage of a signal having the same frequency band as the first communication band out of the signal inputted to the aforementioned input unit (that is to say, the output signal from the first drive stage amplification unit 71), and blocks a signal having the same frequency band as the second communication band. Then, the first matching circuit 73 outputs the signal that is allowed to pass from the aforementioned output unit. The first communication band is n77 (that is to say, a relatively low frequency band), for example, and the second communication band is n79 (a relatively high frequency band), for example. Accordingly, the first matching circuit 73 is the matching circuit of the low pass filter type, for instance.

The second power amplifier 8 is an amplification unit that amplifies the second transmission signal in the second communication band. The second power amplifier 8 is connected between the external terminal 5d and the output matching circuit 9. The second power amplifier 8 is a multistage (two in the example of FIG. 1) amplification unit. The second power amplifier 8 includes the second drive stage amplification unit 81, the final stage amplification unit 72, and the second matching circuit 83. The final stage amplification unit 72 doubles as the final stage amplification unit 72 of the first power amplifier 7. That is to say, the final stage amplification unit 72 is shared by the first power amplifier 7 and the second power amplifier 8.

The second drive stage amplification unit 81 is connected to the subsequent stage of the second input unit 77. The second drive stage amplification unit 81 includes an input unit and an output unit. The input unit of the second drive stage amplification unit 81 is connected to external terminal 5d. The output unit of the second drive stage amplification unit 81 is connected to the input unit of the final stage amplification unit 72 (that is to say, the respective input units of the first amplification unit 74 and the second amplification unit 75) with the second matching circuit 83 interposed therebetween. The second drive stage amplification unit 81 amplifies the signal (the second transmission signal) inputted to the aforementioned input unit at a predetermined amplification factor, and outputs the amplified signal from the aforementioned output unit.

As mentioned earlier, the final stage amplification unit 72 is connected to the precedent stage of the output units 78 and 79. The final stage amplification unit 72 further amplifies the signal that is amplified by the second drive stage amplification unit 81. As described above, the final stage amplification unit 72 includes the first amplification unit 74 and the second amplification unit 75. The first amplification unit 74 includes the input unit and the output unit as mentioned above. The second amplification unit includes the input unit and the output unit as mentioned above. As mentioned earlier, the input unit of the first amplification unit 74 and the input unit of the second amplification unit 75 are connected to each other, and are further connected to the output unit of the second drive stage amplification unit 81 with the second matching circuit 83 interposed therebetween. As described above, the output unit of the first amplification unit 74 and the output unit of the second amplification unit 75 are connected to each other with the balanced side coil 91 interposed therebetween. Specifically, the output unit of the first amplification unit 74 is connected to the first end 91a of the balanced side coil 91, and the output unit of the second amplification unit 75 is connected to the second end 91b of the balanced side coil 91.

The second matching circuit 83 is a matching circuit of a high pass filter type (that is to say, a filter type), for example. The second matching circuit 83 is connected between the second drive stage amplification unit 81 and the final stage amplification unit 72, and achieves impedance matching between the second drive stage amplification unit 81 and the final stage amplification unit 72.

In the meantime, the second matching circuit 83 is configured to function as a high pass filter, for example. To be more precise, the second matching circuit 83 functions as a filter that has the second pass band including the second communication band (such as n79), and a second attenuation band including the first communication band (such as n77). The second matching circuit 83 includes an input unit and an output unit. The input unit of the second matching circuit 83 is connected to the output unit of the second drive stage amplification unit 81. The output unit of the second matching circuit 83 is connected to the input unit of the final stage amplification unit 72 (the respective input units of the first amplification unit 74 and the second amplification unit 75). The second matching circuit 83 allows passage of a signal having the same frequency band as the second communication band out of the signal inputted to the aforementioned input unit (that is to say, the output signal from the second drive stage amplification unit 81), and blocks a signal having the same frequency band as the first communication band. Then, the second matching circuit 83 outputs the signal that is allowed to pass from the aforementioned output unit. The first communication band is n77 (that is to say, the relatively low frequency band), for example, and the second communication band is n79 (the relatively high frequency band), for example. Accordingly, the second matching circuit 83 is the matching circuit of the high pass filter type, for instance.

The first power amplifier 7 and the second power amplifier 8 are integrally formed by using a semiconductor chip 30. Specifically, the semiconductor chip 30 includes the first input unit 76, the second input unit 77, the output units 78 and 79, the first drive stage amplification unit 71, the second drive stage amplification unit 81, the matching circuits 73 and 83, and the final stage amplification unit 72.

In the first power amplifier 7 and the second power amplifier 8 configured as described above, the single final stage amplification unit 72 doubles as the final stage amplification unit 72 of the first power amplifier 7 and the final stage amplification unit 72 of the second power amplifier 8. Accordingly, it is possible to downsize the entirety of the first power amplifier 7 and the second power amplifier 8 (that is to say, the semiconductor chip 30). In other words, the high frequency module 1 can be downsized.

Meanwhile, since the first power amplifier 7 includes the first matching circuit 73 of the low pass filter type, the signal component in the same frequency band as the second communication band out of the output signal from the first drive stage amplification unit 71 can be kept from leaking out to the second drive stage amplification unit 81 side as the unnecessary wave. In the meantime, since the second power amplifier 8 includes the second matching circuit 83 of the high pass filter type, the signal component in the same frequency band as the first communication band out of the output signal from the second drive stage amplification unit 81 can be kept from leaking out to the first drive stage amplification unit 71 side as the unnecessary wave.

### (3.4) Output Matching Circuit

The output matching circuit 9 is connected between the final stage amplification unit 72 and the variable low pass filter 10, and achieves impedance matching between the final stage amplification unit 72 and the variable low pass filter 10. The output matching circuit 9 includes the transformer 90, capacitors C1 to C3, and the variable capacitor C4.

The transformer 90 synthesizes and converts a first amplified balanced signal being an output signal from the first amplification unit 74 and a second amplified balanced signal being an output signal from the second amplification unit 75 into an amplified unbalanced signal, and outputs the converted amplified unbalanced signal to a subsequent stage. The transformer 90 includes the balanced side coil 91, an unbalanced side coil 92, and the capacitor C1.

The balanced side coil 91 is used as a primary coil of the transformer 90. The balanced side coil 91 includes the first end 91a, the second end 91b, and an intermediate tap 91c. The first end 91a is one end of the balanced side coil 91, which is an input end to which the first amplified balanced signal is inputted. The first end 91a is connected to the output unit of the first amplification unit 74. The second end 91b is another end of the balanced side coil 91, which is an input end to which the second amplified balanced signal is inputted. The second end 91b is connected to the output unit of the second amplification unit 75. The intermediate tap 91c is a region which is electrically grounded between the first end 91a and the second end 91b of the balanced side coil 91. The intermediate tap 91c is connected to the ground with the capacitor C1 interposed therebetween. Power is supplied to the first amplification unit 74 and the second amplification unit 75 through the intermediary of this intermediate tap 91c. In this instance, the capacitor C1 functions as a bypass capacitor that reduces unnecessary noise in a power supply channel.

The unbalanced side coil 92 is used as a secondary coil of the transformer 90. The unbalanced side coil 92 is electromagnetically coupled to the balanced side coil 91. The unbalanced side coil 92 includes a third end 92a and a fourth end 92b. The third end 92a is one end of the unbalanced side coil 92, which is an output end from which the above-mentioned amplified unbalanced signal is outputted. The third end 92a is connected to an input unit of the variable low pass filter 10 with the capacitor C2 interposed therebetween. The fourth end 92b is another end of the unbalanced side coil 92, which is connected to the ground.

The capacitors C2 and C3 and the variable capacitor C4 remove high frequency noise components included in the output signal (the above-mentioned amplified unbalanced signal) from the transformer 90. The capacitor C2 is connected between the third end 92a of the unbalanced side coil 92 and the input unit of the variable low pass filter 10. The capacitor C3 and the variable capacitor C4 are connected between a branch point N1, which is located between the third end 92a and the capacitor C2, and the ground and are connected in series with one another. The variable capacitor C4 is a digital variable capacitor, for example. The variable capacitor C4 is disposed inside the antenna switch 6 and formed integrally with the antenna switch 6.

The variable capacitor C4 is a variable element for changing output matching characteristics of the output matching circuit 9 depending on the communication band (the first communication band or the second communication band) of the transmission signal (the output signal from the output unit 78 or 79). To be more precise, when the communication band of the transmission signal is the first communication band, the first communication band (such as n77) is the communication band of the relatively low frequency band. Accordingly, the variable capacitor C4 is adjusted to have larger capacitance. On the other hand, when the communication band of the transmission signal is the second communication band, the second communication band (such as n79) is the communication band of the relatively high frequency band. Accordingly, the variable capacitor C4 is adjusted to have smaller capacitance. The variable capacitor C4 is controlled by a control signal from the controller 24.

### (3.5) Variable Low Pass Filter

The variable low pass filter 10 is a filter for attenuating an unnecessary wave on the high frequency side of the transmission signal (the output signal from the first output unit 78 or 79). The variable low pass filter 10 is a low pass filter having a changeable pass band. To be more precise, the variable low pass filter 10 has a pass band which is a changeable band and designed to allow passage of the signal, and an attenuation band which is a band on a higher frequency side than the pass band and designed to attenuate (that is, to block) the signal. The pass band of the variable low pass filter 10 is changed so as to conform to the communication band of the transmission signal. The state in which the pass band of the variable low pass filter 10 conforms to the communication band of the transmission signal is equivalent to a state in which the upper limit (a cutoff frequency) of the pass band of the variable low pass filter 10 is brought in line with or close to (even closer to) the upper limit of the pass band. That is to say, the variable low pass filter 10 causes the pass band of the variable low pass filter 10 to be change so as to conform to the first communication band when the communication band of the transmission signal is the first communication band, and causes the pass band of the variable low pass filter 10 to be changed so as to conform to the second communication band when the communication band of the transmission signal is the second communication band. The variable low pass filter 10 is controlled by a control signal from the controller 24.

The variable low pass filter 10 includes the input unit and the output unit. The input unit of the variable low pass filter 10 is connected to an output unit of the output matching circuit 9 (that is to say, a subsequent stage of the capacitor C2). The output unit of the variable low pass filter 10 is connected to the terminal 6a of the antenna switch 6 with the transmission line TL1 interposed therebetween. The variable low pass filter 10 allows passage of a signal component in the same frequency band as the communication band of the above-mentioned transmission signal out of the signal (the transmission signal) inputted to the above-mentioned input unit, and blocks a signal component in a frequency band higher than the communication band of the above-mentioned transmission signal. To be more precise, at the time of transmission of the first transmission signal in the first communication band, the pass band of the variable low pass filter 10 is changed so as to conform to the first communication band. Accordingly, the variable low pass filter 10 allows passage of the signal component in the same frequency band as the first communication band, and blocks the signal component in the frequency band higher than the first communication band. Meanwhile, at the time of transmission of the second transmission signal in the second communication band, the pass band of the variable low pass filter 10 is changed so as to conform to the second communication band.

Accordingly, the variable low pass filter 10 allows passage of the signal component in the same frequency band as the second communication band, and blocks the signal component in the frequency band higher than the second communication band. Then, the transmission signal having passed through the variable low pass filter 10 is outputted from the output unit to a subsequent stage.

The variable low pass filter 10 is connected to a subsequent stage of the output units 78 and 79. Here, the state of being “connected to the subsequent stage of the output units 78 and 79” includes a case of being indirectly connected to the output units 78 and 79 with an electronic component (such as the output matching circuit 9) interposed therebetween and a case of being directly connected to the output units 78 and 79 without an electronic component interposed therebetween. In the present embodiment, the variable low pass filter 10 is connected to the output units 78 and 79 with the output matching circuit 9 interposed therebetween.

The variable low pass filter 10 includes the variable capacitor C5 for changing the pass band. The pass band of the variable low pass filter 10 is changed so as to conform to the communication band of the transmission signal by changing the capacitance of the variable capacitor C5. The variable capacitor C5 is disposed inside the antenna switch 6, and is formed integrally with the antenna switch 6.

### (3.6) Multiband Coupler

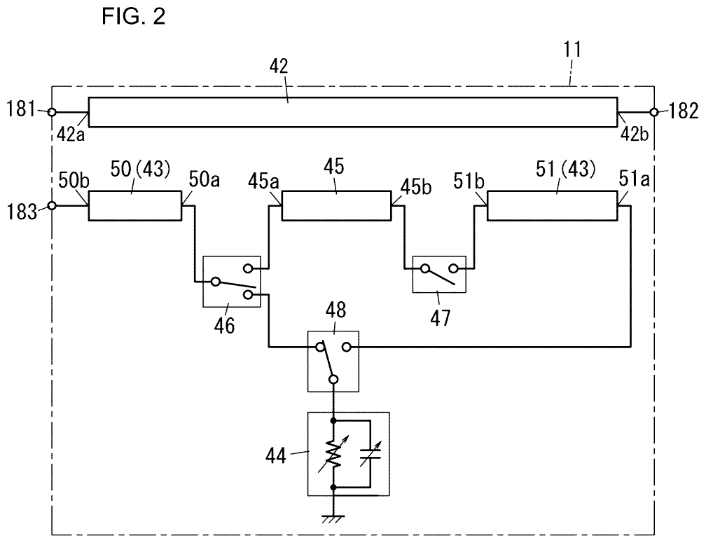

The multiband coupler 11 is a device configured to retrieve a portion of the transmission signal (the high frequency signal) that passes through a main line 42, which is a partial section of the transmission line TL1 (see FIG. 1) inside the high frequency module 1, as the detected signal from a sub-line 43 that is electromagnetically coupled to the main line 42 (see FIG. 2). The multiband coupler 11 includes the sub-line 43, which is magnetically coupled to the main line 42 and has a changeable length, and is configured to detect the transmission signal in the communication band corresponding to the length of the sub-line 43. By changing the length of the sub-line 43 to the length corresponding to the communication band (the first communication band or the second communication band) of the transmission signal, the multiband coupler 11 detects the transmission signal passing through the main line 42. To be more precise, at the time of transmission of the first transmission signal in the first communication band, the multiband coupler 11 detects the first transmission signal flowing on the main line 42 by changing the length of the sub-line 43 to the length corresponding to the first communication band (a sum of a length of a first sub-line 50 and a length of a second sub-line 51). At the time of transmission of the second transmission signal in the second communication band, the multiband coupler 11 detects the second transmission signal passing through the main line 42 by changing the length of the sub-line 43 to the length corresponding to the second communication band (the length of the first sub-line 50). The multiband coupler 11 is controlled by a control signal from the controller 24.

To be more precise, as shown in FIG. 2, the multiband coupler 11 includes the main line 42, the sub-line 43, a termination circuit 44, a first phase shifting circuit 45, a first changeover switch 46, a second changeover switch 47, and a termination switch 48. In addition, as mentioned above, the multiband coupler 11 includes a first connection terminal 181, a second connection terminal 182, and a third connection terminal 183.

The first connection terminal 181 is a terminal connected to the output unit of the variable low pass filter 10 (see FIG. 1), to which an output signal (the transmission signal of a target of detection) from the variable low pass filter 10 is inputted. The second connection terminal 182 is a terminal connected to the terminal 6a of the antenna switch 6 (see FIG. 1), which outputs the detected transmission signal to the terminal 6a. The third connection terminal 183 is a terminal for outputting the detected signal obtained by the detection, which is connected to the external terminal 5j (see FIG. 1).

The main line 42 is a line to pass the transmission signal (the high frequency signal) of the target of detection, which constitutes a part of the transmission line TL1. A first end 42a of the main line 42 is connected to the first connection terminal 181. A second end 42b of the main line 42 is connected to the second connection terminal 182.

The sub-line 43 is a line electromagnetically coupled to the main line 42, which retrieves a portion of the high frequency signal (the transmission signal) flowing on the main line 42 as the detected signal. The sub-line 43 includes the first sub-line 50 and the second sub-line 51. A first end 50a of the first sub-line 50 is connected to the first changeover switch 46. A second end 50b of the first sub-line 50 is connected to the third connection terminal 183. A first end 51a of the second sub-line 51 is connected to the termination switch 48. A second end 51b of the second sub-line 51 is connected to the second changeover switch 47.

The termination circuit 44 is a circuit for terminating any one of the first sub-line 50 and the second sub-line 51.

The first phase shifting circuit 45 is a circuit connected between the first sub-line 50 and the second sub-line 51 used as the sub-line 43 and configured to adjust the phase of the sub-line 43 in a second mode to be described later. The first phase shifting circuit 45 adjusts the phase of the sub-line 43 in the second mode, thereby suppressing leakage of a signal having a high frequency from the main line 42 to the sub-line 43. The first phase shifting circuit 45 is provided between the first end 50a of the first sub-line 50 and the second end 51b of the second sub-line 51.

The first changeover switch 46 changes a connection destination of the first end 50a of the first sub-line 50 to one of a first end 45a of the first phase shifting circuit 45 and the termination switch 48. The second changeover switch 47 is provided between the first phase shifting circuit 45 and the second sub-line 51, and switches connection and disconnection between a second end 45b of the first phase shifting circuit 45 and the second end 51b of the second sub-line 51. The termination switch 48 changes a connection destination of the termination circuit 44 to any one of the first changeover switch 46 and the first end 51a of the second sub-line 51.

The first changeover switch 46, the second changeover switch 47, and the termination switch 48 are controlled by control signals from the controller 24.

The multiband coupler 11 has a first mode and the second mode.

The first mode is a mode of detecting the transmission signal in the first communication band out of the high frequency signal flowing on the main line 42. In the first mode, the first changeover switch 46 changes the connection destination of the first end 50a of the first sub-line 50 to the first phase shifting circuit 45, the second changeover switch 47 connects the first phase shifting circuit 45 to the second end 51b of the second sub-line 51, and the termination switch 48 changes the connection destination of the termination circuit 44 to the first end 51a of the second sub-line 51. As a consequence, the sub-line 43 in the first mode is constituted by a series circuit including the first sub-line 50, the first phase shifting circuit 45, and the second sub-line 51. In the first mode, the transmission signal in the first communication band is detected out of the high frequency signal flowing on the main line 42 by using the above-described series circuit as the sub-line 43.

The second mode is a mode of detecting the transmission signal in the second communication band out of the high frequency signal flowing on the main line 42. In the second mode, the first changeover switch 46 changes the connection destination of the first end 50a of the first sub-line 50 to the termination switch 48, and the termination switch 48 changes the connection destination of the termination circuit 44 to the first end 50a of the first sub-line 50. As a consequence, the sub-line 43 in the second mode is constituted by the first sub-line 50. In the second mode, the transmission signal in the second communication band is detected out of the high frequency signal flowing on the main line 42 by using the first sub-line 50 as the sub-line 43.

### (3.7) High Pass Filters

The high pass filters 12 and 13 are filters for attenuating unnecessary waves (which include signal components in the Industrial Scientific and Medical Band (ISM) band, for example) on a low frequency side of the transmission signal and the reception signal. The high pass filters 12 and 13 include inductors for electrostatic discharge (ESD) protection. The high pass filter 12 is connected between the terminal 6b of the antenna switch 6 and the external terminal 5a. The high pass filter 13 is connected between the terminal 6c of the antenna switch 6 and the external terminal 5b. Each of the first antenna 3 and the second antenna 4 can be used for transmission of the first transmission signal in the first communication band and transmission of the second transmission signal in the second communication band. In the meantime, each of the first antenna 3 and the second antenna 4 can be used for reception of the first reception signal in the first communication band and reception of the second reception signal in the second communication band.

### (3.8) Diplexers

The diplexer 14 includes multiple (two in the example of FIG. 1) reception filters 14R1 and 14R2. The reception filter 14R1 is a filter that adopts a reception band in the first communication band as the pass band. The reception filter 14R2 is a filter that adopts a reception band in the second communication band as the pass band. Each of the reception filters 14R1 and 14R2 includes an input unit and an output unit. A single input unit doubles as the input unit of the reception filter 14R1 and the input unit of the reception filter 14R2, and is connected to the terminal 6d of the antenna switch 6. The output unit of the reception filter 14R1 is connected to an input unit of the low noise amplifier 20 with the matching circuit 16 interposed therebetween. The output unit of the reception filter 14R2 is connected to an input unit of the low noise amplifier 21 with the matching circuit 17 interposed therebetween. The reception filter 14R1 allows passage of only a signal component in the same frequency band as the first band out of a signal (the reception signal) inputted to the input unit of the reception filter 14R1, and outputs the signal that is allowed to pass from the output unit of the reception filter 14R1. The reception filter 14R2 allows passage of only a signal component in the same frequency band as the second communication band out of a signal (the reception signal) inputted to the input unit of the reception filter 14R2, and outputs the signal that is allowed to pass from the output unit of the reception filter 14R2.

The diplexer 15 is formed as with the diplexer 14. The diplexer 15 includes multiple (two in the example of FIG. 1) reception filters 15R1 and 15R2. The reception filter 15R1 is a reception filter that adopts the reception band in the first communication band as the pass band. The reception filter 15R2 is a reception filter that adopts the reception band in the second communication band as the pass band. Each of the reception filters 15R1 and 15R2 includes an input unit and an output unit. A single input unit doubles as the input unit of the reception filter 15R1 and the input unit of the reception filter 15R2, and is connected to the terminal 6e of the antenna switch 6. The output unit of the reception filter 15R1 is connected to an input unit of the low noise amplifier 22 with the matching circuit 18 interposed therebetween. The output unit of the reception filter 15R2 is connected to an input unit of the low noise amplifier 23 with the matching circuit 19 interposed therebetween. The reception filter 15R1 allows passage of only a signal component in the same frequency band as the first communication band out of a signal (the reception signal) inputted to the input unit of the reception filter 15R1, and outputs the signal that is allowed to pass from the output unit of the reception filter 15R1. The reception filter 15R2 allows passage of only a signal component in the same frequency band as the second communication band out of a signal (the reception signal) inputted to the input unit of the reception filter 15R2, and outputs the signal that is allowed to pass from the output unit of the reception filter 15R2.

### (3.9) Low Noise Amplifiers

The low noise amplifier 20 is connected between the output unit of the reception filter 14R1 and the external terminal 5e, and amplifies the output signal from the reception filter 14R1. The low noise amplifier 20 includes the input unit and an output unit. The input unit of the low noise amplifier 20 is connected to the output unit of the reception filter 14R1 with the matching circuit 16 interposed therebetween. The output unit of the low noise amplifier 20 is connected to the external terminal 5e. The low noise amplifier 20 amplifies the signal (the reception signal) inputted to the above-mentioned input unit and outputs the amplified signal from the above-mentioned output unit.

The low noise amplifier 21 is connected between the output unit of the reception filter 14R2 and the external terminal 5f, and amplifies the output signal from the reception filter 14R2. The low noise amplifier 21 includes the input unit and an output unit. The input unit of the low noise amplifier 21 is connected to the output unit of the reception filter 14R2 with the matching circuit 17 interposed therebetween. The output unit of the low noise amplifier 20 is connected to the external terminal 5f. The low noise amplifier 21 amplifies the signal (the reception signal) inputted to the above-mentioned input unit and outputs the amplified signal from the above-mentioned output unit.

The low noise amplifier 22 is connected between the output unit of the reception filter 15R1 and the external terminal 5g, and amplifies the output signal from the reception filter 15R1. The low noise amplifier 22 includes the input unit and an output unit. The input unit of the low noise amplifier 22 is connected to the output unit of the reception filter 15R1 with the matching circuit 18 interposed therebetween. The output unit of the low noise amplifier 22 is connected to the external terminal 5g. The low noise amplifier 22 amplifies the signal (the reception signal) inputted to the above-mentioned input unit and outputs the amplified signal from the above-mentioned output unit.

The low noise amplifier 23 is connected between the output unit of the reception filter 15R2 and the external terminal 5h, and amplifies the output signal from the reception filter 15R2. The low noise amplifier 23 includes the input unit and an output unit. The input unit of the low noise amplifier 23 is connected to the output unit of the reception filter 15R2 with the matching circuit 19 interposed therebetween. The output unit of the low noise amplifier 23 is connected to the external terminal 5h. The low noise amplifier 23 amplifies the signal (the reception signal) inputted to the above-mentioned input unit and outputs the amplified signal from the above-mentioned output unit.

### (3.10) Matching Circuits

The matching circuit 16 is connected between the reception filter 14R1 and the low noise amplifier 20 and achieves impedance matching between the reception filter 14R1 and the low noise amplifier 20. The matching circuit 17 is connected between the reception filter 14R2 and the low noise amplifier 21 and achieves impedance matching between the reception filter 14R2 and the low noise amplifier 21. The matching circuit 18 is connected between the reception filter 15R1 and the low noise amplifier 22 and achieves impedance matching between the reception filter 15R1 and the low noise amplifier 22. The matching circuit 19 is connected between the reception filter 15R2 and the low noise amplifier 23 and achieves impedance matching between the reception filter 15R2 and the low noise amplifier 23.

### (3.11) Controller

The controller 24 controls the electronic components (the antenna switch 6, the power amplifiers 7 and 8, the output matching circuit 9, the variable low pass filter 10, the multiband coupler 11, the matching circuits 16 to 19, and the low noise amplifiers 20 to 23, for example) included in the high frequency module 1 in accordance with the control signals from the signal processing circuit 2. The controller 24 is electrically connected to the aforementioned electronic components. The controller 24 is connected to the signal output unit of the signal processing circuit 2 with the external terminal 5i interposed therebetween. The controller 24 controls the respective electronic components mentioned above in accordance with the control signals inputted from the signal processing circuit 2 to the external terminal 5i.

### (4) Explanation of Operations of High Frequency Module 1

Operations of the high frequency module 1 will be explained with reference to FIG. 1.

(4-1) Operation when Transmitting First Transmission Signal in First Communication Band (Such as n77)

In the case of transmitting the first transmission signal in the first communication band, the terminal 6a of the antenna switch 6 is connected to one terminal (such as the terminal 6b) out of the two terminals 6b and 6c. Meanwhile, the first drive stage amplification unit 71 is powered on and the second drive stage amplification unit 81 is powered off. In the meantime, the output matching circuit 9 is adjusted such that the matching characteristics of the output matching circuit 9 conform to the first communication band by adjusting the capacitance of the variable capacitor C4. For example, the capacitance of the variable capacitor C4 is adjusted to be larger. Meanwhile, regarding the variable low pass filter 10, the pass band of the variable low pass filter 10 is adjusted to conform to the first communication band by adjusting the capacitance of the variable capacitor C5. In the meantime, the multiband coupler 11 is adjusted such that the sub-line 43 becomes a sub-line having the length corresponding to the first communication band (that is to say, the series circuit including the first sub-line 50, the first phase shifting circuit 45, and the second sub-line 51).

Then, the first transmission signal in the first communication band is inputted from the signal processing circuit 2 to the external terminal 5c in the state where the respective units (the antenna switch 6, the output matching circuit 9, the variable low pass filter 10, and the multiband coupler 11) are adjusted as described above. The inputted first transmission signal is routed through the first drive stage amplification unit 71, the matching circuit 73, the final stage amplification unit 72, the output matching circuit 9, the variable low pass filter 10, the multiband coupler 11, the antenna switch 6, and the high pass filter 12, and is transmitted from the antenna 3 to the outside. In this instance, the matching circuit 73 is the matching circuit of the low pass filter type, for example, and therefore allows passage of the signal in the same frequency band as the first communication band out of the output signal from the first drive stage amplification unit 71, and attenuates the signal (the unnecessary wave) in the same frequency band as the second communication band. Accordingly, it is possible to reduce a signal level deviating to the matching circuit 83 side caused by the signal being the unnecessary wave in the same frequency band as the second communication band out of the output signal from the first drive stage amplification unit 71. This unnecessary wave would generate a strain component at the second drive stage amplification unit 81 that is powered off. However, the matching circuit 73 can suppress generation of the strain component. Meanwhile, the variable capacitor C4 is adjusted such that the output matching characteristics of the output matching circuit 9 are adjusted to conform to the first communication band. Accordingly, a signal loss at the time of passage of the first transmission signal through the output matching circuit 9 is further suppressed. In the meantime, since the pass band of the variable low pass filter 10 is adjusted to conform to the first communication band, a signal (the unnecessary wave) on the high frequency side of the first communication band is further reduced. Meanwhile, since the length of the sub-line 43 of the multiband coupler 11 is adjusted to the length corresponding to the first communication band, the first transmission signal in the first communication band is effectively detected. In the meantime, a signal (the unnecessary wave) on a low frequency side lower than the first transmission signal is reduced by the high pass filter 12.

(4-2) Operation when Transmitting Second Transmission Signal in Second Communication Band (Such as n79)

An operation in the case of transmitting the second transmission signal in the second communication band is the same as the operation in the case of transmitting the first transmission signal in the first communication band except for the following different points that the first drive stage amplification unit 71 is powered off, that the second drive stage amplification unit 81 is powered on, that the output matching characteristics of the output matching circuit 9 are adjusted to conform to the second communication band, that the pass band of the variable low pass filter 10 is adjusted to conform to the second communication band, that the sub-line 43 of the multiband coupler 11 is adjusted to the sub-line having the length corresponding to the second communication band, and that the second transmission signal is inputted from the signal processing circuit 2 to the external terminal 5d instead of the first transmission signal, and detailed explanations will therefore be omitted. Here, the matching circuit 83 is the matching circuit of the high pass filter type, for example, and therefore allows passage of the signal in the same frequency band as the second communication band out of the output signal from the second drive stage amplification unit 81, and attenuates the signal (the unnecessary wave) in the same frequency band as the first communication band. Accordingly, it is possible to reduce a signal level deviating to the matching circuit 73 side caused by the signal being the unnecessary wave in the same frequency band as the first communication band out of the output signal from the second drive stage amplification unit 81. This unnecessary wave would generate a strain component at the second drive stage amplification unit 81 that is powered off. However, the matching circuit 83 can suppress generation of the strain component.

(4-3) Operation when Receiving First Reception Signal in First Communication Band (Such as n77)

In the case of receiving the first reception signal in the first communication band, one reception terminal (such as the terminal 6b) is selected from the terminals 6b and 6c of the antenna switch 6. Meanwhile, one connection destination (such as the terminal 6d) of the above-mentioned reception terminal is selected from the terminals 6d and 6e of the antenna switch 6. Then, the selected terminal 6b is connected to the selected terminal 6d. Thereafter, when the antenna 3 receives the first reception signal in the first communication band in this state of connection, the received first reception signal is routed through the high pass filter 12, the antenna switch 6, the reception filter 14R1, the matching circuit 16, and the low noise amplifier 20, and is outputted from the external terminal 5e to the signal processing circuit 2.

(4-4) Operation when Receiving Second Reception Signal in Second Communication Band (Such as n79)

In the case of receiving the second reception signal in the second communication band, one reception terminal (such as the terminal 6b) is selected from the terminals 6b and 6c of the antenna switch 6. Meanwhile, one connection destination (such as the terminal 6d) of the above-mentioned reception terminal is selected from the terminals 6d and 6e of the antenna switch 6. Then, the selected terminal 6b is connected to the selected terminal 6d. Thereafter, when the antenna 3 receives the second reception signal in the second communication band in this state of connection, the received second reception signal is routed through the high pass filter 12, the antenna switch 6, the reception filter 14R2, the matching circuit 17, and the low noise amplifier 21, and is outputted from the external terminal 5f to the signal processing circuit 2.

### (5) Effects

As described above, the high frequency module 1 according to the embodiment includes the first input unit 76, the second input unit 77, the output units 78 and 79 (the first output units), the first drive stage amplification unit 71, the second drive stage amplification unit 81, the final stage amplification unit 72, the first matching circuit 73, and the second matching circuit 83. The first transmission signal in the first communication band is inputted to the first input unit 76. The second transmission signal in the second communication band different from the first communication band is inputted to the second input unit 77. The first drive stage amplification unit 71 is connected to the subsequent stage of the first input unit 76. The second drive stage amplification unit 81 is connected to the subsequent stage of the second input unit 77. The final stage amplification unit 72 is connected to the precedent stage of the output units 78 and 79. The first matching circuit 73 is the matching circuit of the filter type which is connected between the first drive stage amplification unit 71 and the final stage amplification unit 72, and has the first pass band including the first communication band and the first attenuation band including the second communication band. The second matching circuit 83 is the matching circuit of the filter type which is connected between the second drive stage amplification unit 81 and the final stage amplification unit 72, and has the second pass band including the second communication band and the second attenuation band including the first communication band.

According to this configuration, the single final stage amplification unit 72 doubles as the final stage amplification unit 72 for the first communication band and the final stage amplification unit 72 for the second communication band which account for high occupancy rates, thereby enabling downsizing of the high frequency module 1.

Meanwhile, since the first matching circuit 73 of the filter type is connected between the first drive stage amplification unit 71 and the final stage amplification unit 72, the signal in the same frequency band as the second communication band out of the output signal from the first drive stage amplification unit 71 can be kept from leaking out to the second drive stage amplification unit 81 side as the unnecessary wave. In the meantime, since the second matching circuit 83 of the filter type is connected between the second drive stage amplification unit 81 and the final stage amplification unit 72, the signal in the same frequency band as the first communication band out of the output signal from the second drive stage amplification unit 81 can be kept from leaking out to the first drive stage amplification unit 71 side as the unnecessary wave. That is to say, it is possible to suppress leakage of the unnecessary waves between the power amplifiers 7 and 8.

Meanwhile, in the high frequency module 1 according to the embodiment, the frequency band of the second communication band is higher than the frequency band of the first communication band. The first matching circuit 73 is the matching circuit of the low pass filter type. The second matching circuit 83 is the matching circuit of the high pass filter type. According to this configuration, in the case where the frequency band of the second communication band is higher than the frequency band of the first communication band, it is possible to suppress the leakage of the unnecessary wave included in the output signal from the first drive stage amplification unit 71 out to the second drive stage amplification unit 81 side by attenuating the unnecessary wave with the first matching circuit 73, and the leakage of the unnecessary wave included in the output signal from the second drive stage amplification unit 81 out to the first drive stage amplification unit 71 side by attenuating the unnecessary wave with the first matching circuit 83.

Meanwhile, the high frequency module 1 according to the embodiment further includes the variable low pass filter 10. The variable low pass filter 10 is connected to the subsequent stage of the output units 78 and 79. The pass band of the variable low pass filter 10 is changed depending on the communication band of the transmission signal outputted from the output unit 78 or 79. According to this configuration, unnecessary harmonic wave components included in the output signal from the output units 78 and 79 can further be attenuated with the variable low pass filter 10. Moreover, it is not necessary to provide each communication band with the low pass filter by using the variable low pass filter 10 instead. As a consequence, it is possible to reduce the number of the low pass filters and to downsize the high frequency module 1.

In the meantime, the high frequency module 1 according to the embodiment further includes the external terminals 5a and 5b (one or more antenna terminals), and the antenna switch 6. The antenna switch 6 is connected to the subsequent stage of the variable low pass filter 10 and to the external terminals 5a and 5b. The variable low pass filter 10 includes the variable capacitor C5. The variable capacitor C5 changes depending on the communication band of the transmission signal outputted from the first output unit 78 or 79. The variable capacitor C5 is formed integrally with the antenna switch 6. According to this configuration, it is possible to downsize the variable low pass filter 10.

Meanwhile, the high frequency module 1 according to the embodiment further includes the multiband coupler 11. The multiband coupler 11 is provided on the transmission line TL1 located between the variable low pass filter 10 and the antenna switch 6, and detects the transmission signal that passes through the transmission line TL1. The multiband coupler 11 includes the sub-line 43, which is electromagnetically coupled to the transmission line TL1 and has the changeable length. By changing the length of the sub-line 43 to the length corresponding to the communication band of the transmission signal, the multiband coupler 11 detects the aforementioned transmission signal. According to this configuration, the use of the multiband coupler 11 enables the single multiband coupler 11 to detect the transmission signals in the multiple communication bands, and to control the output of the transmission signal accurately for each communication band.

In the meantime, the high frequency module 1 according to the embodiment further includes the high pass filters 12 and 13. The high pass filters 12 and 13 are connected between the antenna switch 6 and the antenna terminals 5a and 5b. According to this configuration, an unnecessary low frequency component included in the transmission signal can be attenuated by using the high pass filters 12 and 13.

Meanwhile, the high frequency module 1 according to the embodiment further includes the output matching circuit 9. The output matching circuit 9 is connected between the output units 78 and 79 and the variable low pass filter 10. The final stage amplification unit 72 includes the first amplification unit 74 and the second amplification unit 75. The respective input units of the first amplification unit 74 and the second amplification unit 75 are connected to each other. The output matching circuit 9 includes the transformer 90. The transformer 90 includes the balanced side coil 91 and the unbalanced side coil 92. The balanced side coil 91 includes the first end 91a and the second end 91b. The first end 91a is connected to the output unit of the first amplification unit 74. The second end 91b is connected to the output unit of the second amplification unit 75. The unbalanced side coil 92 includes the third end 92a and the fourth end 92b. The third end 92a is connected to the input unit of the variable low pass filter 10. The fourth end 92b is connected to the ground. According to this configuration, in the case where the final stage amplification unit 72 is an amplifier of a differential type, the final stage amplification unit 72 is shared by the power amplifiers 7 and 8, so that the high frequency module 1 can be downsized. Moreover, it is possible to suppress leakage of the unnecessary waves between the power amplifiers 7 and 8.

In the meantime, the high frequency module 1 according to the embodiment includes the external terminals 5a and 5b (one or more antenna terminals), and the antenna switch 6. The antenna switch 6 is connected to the subsequent stage of the variable low pass filter 10 and to the external terminals 5a and 5b. The output matching circuit 9 further includes the variable capacitor C4. The variable capacitor C4 is connected between the transmission line, which is located between the transformer 90 and the variable low pass filter 10, and the ground. The capacitance of the variable capacitor C4 is changed depending on the communication band of the output signal from the output unit 78 or 79. The variable capacitor C4 is formed integrally with the antenna switch 6.

According to this configuration, it is possible to downsize the output matching circuit 9 since the variable capacitor C4 of the output matching circuit 9 is formed integrally with the antenna switch 6. Meanwhile, since the variable capacitor C4 is changeable depending on the communication band of the output signal from the variable low pass filter 10, the output matching characteristics of the output matching circuit 9 can be changed depending on the communication band of the output signal from the variable low pass filter 10. In this way, the output matching characteristics of the output matching circuit 9 can be changed to an optimum value depending on the communication band of the output signal from the variable low pass filter 10.

In the meantime, in the high frequency module 1 according to the embodiment, the first communication band is n77, and the second communication band is n79. According to this configuration, the high frequency module 1 can be downsized and the leakage of the unnecessary waves between the power amplifiers 7 and 8 can be suppressed in the case where the first communication band is n77 and the second communication band is n79.

Meanwhile, the communication apparatus 200 according to the embodiment includes the high frequency module 1 and the signal processing circuit 2. The signal processing circuit 2 is connected to the high frequency module 1 and performs signal processing of a high frequency signal. According to this configuration, it is possible to provide the communication apparatus 200 that brings about the effects of the high frequency module 1.

### (6) Modified Examples

Modified examples of the aforementioned embodiment will be described. In the following description, explanations of the same portions as those of the above-described embodiment may be omitted and only different portions from those of the above-described embodiment may be explained in some cases. Note that the following modified examples can be carried out in combination.

### (6-1) Modified Example 1

### (6-1-1) Configuration

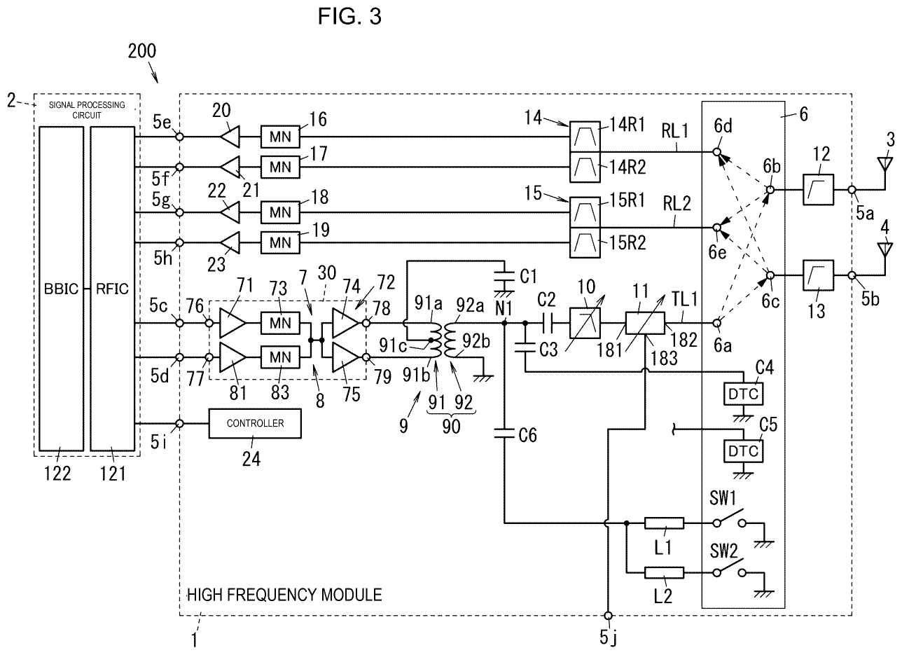

As shown in FIG. 3, in the above-described embodiment, the output matching circuit 9 further includes multiple (two in the example of FIG. 3) inductors L1 and L2, and multiple switches SW1 and SW2.

The inductor L1 is connected in series between a branch point N1 of a transmission line, which is located between the transformer 90 and the variable low pass filter 10 (more specifically, a transmission line located between the transformer 90 and the capacitor C2), and the ground with a capacitor C6 interposed therebetween. The inductor L2 is connected in series between the branch point N1 and the ground. That is to say, the inductor L2 is connected in parallel with the inductor L1.

The multiple switches SW1 and SW2 correspond one-on-one to the multiple inductors L1 and L2. The switch SW1 is connected between the corresponding inductor L1 and the ground, and changes connection and disconnection between the inductor L1 and the ground. To be more precise, the switch SW1 is changed to the on state so as to connect the inductor L1 to the ground, and is changed to the off state so as to disconnect the inductor L1 from the ground. The switch SW2 is connected between the corresponding inductor L2 and the ground, and changes connection and disconnection between the inductor L2 and the ground. To be more precise, the switch SW2 is changed to the on state so as to connect the inductor L2 to the ground, and is changed to the off state so as to disconnect the inductor L2 from the ground. The switch SW1 is controlled by a control signal from the controller 24.

The switches SW1 and SW2 are disposed inside the antenna switch 6 and are formed integrally with the antenna switch 6.

At the time of transmission of the first transmission signal in the first communication band, the switch SW1 is changed to the on state and the switch SW2 is changed to the off state, for example. In this case, the inductor of the output matching circuit 9 is constituted by the inductor L1 out of the inductors L1 and L2. Specifically, the inductor of the output matching circuit 9 is changed to the inductor corresponding to the first communication band. Meanwhile, at the time of transmission of the second transmission signal in the second communication band, both of the switches SW1 and SW2 are changed to the on state, for example. In this case, the inductor of the output matching circuit 9 is constituted by a combined inductor of the inductors L1 and L2 (the inductors L1 and L2 connected in parallel with each other). Accordingly, the inductor of the output matching circuit 9 is changed to the inductor corresponding to the second communication band.

### (6-1-2) Effects

The high frequency module 1 according to the modified example 1 includes the external terminals 5a and 5b (one or more antenna terminals), and the antenna switch 6. The antenna switch 6 is connected to the subsequent stage of the variable low pass filter 10 and to the external terminals 5a and 5b. The output matching circuit 9 includes the multiple inductors L1 and L2 and the multiple switches SW1 and SW2. The multiple inductors L1 and L2 are connected between the transmission line, which is located between the transformer 90 and the variable low pass filter 10, and the ground and are connected in parallel with each other. The multiple switches SW1 and SW2 correspond to the inductors L1 and L2, and each connect and disconnect the corresponding inductor (L1 or L2) to and from the ground depending on the communication band of the output signal from the first output unit 78 or 79. The multiple switches SW1 and SW2 are formed integrally with the antenna switch 6.

According to this configuration, the output matching circuit 9 can be downsized since the multiple switches SW1 and SW2 are formed integrally with the antenna switch 6. Meanwhile, since the multiple switches SW1 and SW2 are connected and disconnected depending on the communication band of the output signal from the variable low pass filter 10, the inductor of the output matching circuit 9 on the whole can be changed depending on the communication band of the output signal from the variable low pass filter 10. Thus, the output matching characteristics of the output matching circuit 9 can be changed depending on the communication band of the output signal from the first output unit 78 or 79.

### (6-2) Other Modified Examples

The above-described embodiment exemplifies the case where the final stage amplification unit 72 is constituted by the two amplification units 74 and 75 connected in parallel. However, the final stage amplification unit 72 may be constituted by a single amplification unit instead.

Meanwhile, the above-described embodiment exemplifies the case in which the first power amplifier 7 and the second power amplifier 8 amplify the transmission signals in the different communication bands (the first communication band and the second communication band), respectively. However, the first power amplifier 7 and the second power amplifier 8 may constitute a Doherty-type power amplifier. Specifically, the first power amplifier 7 may be a carrier-type amplification unit and the second power amplifier 8 may be a peaking amplification unit.

In the meantime, the above-described embodiment exemplifies the case of providing the multiple (two in FIG. 1) antennas 3 and 4. However, one antenna (such as the antenna 3 alone) may be provided instead. In this case, the antenna 4, the external terminal 5b, and the terminal 6c of the antenna switch 6 are omitted.

Meanwhile, the high frequency module 1 according to the above-described embodiment exemplifies the case of including the output matching circuit 9, the variable low pass filter 10, the multiband coupler 11, and the high pass filters 12 and 13. However, it is not always necessary to provide all of those constituents (the output matching circuit 9, the variable low pass filter 10, the multiband coupler 11, and the high pass filters 12 and 13), and selected constituents therefrom may be provided as appropriate.

### ASPECTS

The present specification discloses the following aspects.

A high frequency module (1) according to a first aspect includes a first input unit (76), a second input unit (77), a first output unit (78, 79), a first drive stage amplification unit (71), a second drive stage amplification unit (81), a final stage amplification unit (72), a first matching circuit (73), and a second matching circuit (83). A first transmission signal in a first communication band is inputted to the first input unit (76). A second transmission signal in a second communication band different from the first communication band is inputted to the second input unit (77). The first drive stage amplification unit (71) is connected to a subsequent stage of the first input unit (76). The second drive stage amplification unit (81) is connected to a subsequent stage of the second input unit (77). The final stage amplification unit (72) is connected to a precedent stage of the first output unit (78, 79). The first matching circuit (73) is a matching circuit of a filter type which is connected between the first drive stage amplification unit (71) and the final stage amplification unit (72), and has a first pass band including the first communication band and a first attenuation band including the second communication band. The second matching circuit (83) is a matching circuit of a filter type which is connected between the second drive stage amplification unit (81) and the final stage amplification unit (72), and has a second pass band including the second communication band and a second attenuation band including the first communication band.

According to this configuration, the single final stage amplification unit (72) doubles as the final stage amplification unit (72) for the first communication band and the final stage amplification unit (72) for the second communication band which account for high occupancy rates, thereby enabling downsizing of the high frequency module (1).

Meanwhile, since the first matching circuit (73) of the filter type is connected between the first drive stage amplification unit (71) and the final stage amplification unit (72), the signal in the same frequency band as the second communication band out of an output signal from the first drive stage amplification unit (71) can be kept from leaking out to the second drive stage amplification unit (81) side as an unnecessary wave. In the meantime, since the second matching circuit (83) of the filter type is connected between the second drive stage amplification unit (81) and the final stage amplification unit (72), a signal in the same frequency band as the first communication band out of an output signal from the second drive stage amplification unit (81) can be kept from leaking out to the first drive stage amplification unit (71) side as an unnecessary wave. That is to say, it is possible to suppress leakage of the unnecessary waves between power amplifiers (7, 8).

In the high frequency module (1) of a second aspect according to the first aspect, a frequency band of the second communication band is higher than a frequency band of the first communication band. The first matching circuit (73) is a matching circuit of a low pass filter type. The second matching circuit (83) is a matching circuit of a high pass filter type.

According to this configuration, in the case where the frequency band of the second communication band is higher than the frequency band of the first communication band, it is possible to suppress leakage of the unnecessary wave included in the output signal from the first drive stage amplification unit (71) out to the second drive stage amplification unit (81) side, and leakage of the unnecessary wave included in the output signal from the second drive stage amplification unit (81) out to the first drive stage amplification unit (71) side.

The high frequency module (1) of a third aspect according to the first or second aspect further includes a variable low pass filter (10). The variable low pass filter (10) is connected to a subsequent stage of the first output unit (78, 79). A pass band of the variable low pass filter (10) is changed depending on a communication band of a transmission signal outputted from the first output unit (78, 79).

According to this configuration, unnecessary harmonic wave components included in the output signal from the output unit can further be attenuated with the variable low pass filter (10). Moreover, it is not necessary to provide each communication band with the low pass filter by using the variable low pass filter (10) instead. As a consequence, it is possible to reduce the number of the low pass filters and to downsize the high frequency module (1).

The high frequency module (1) of a fourth aspect according to the third aspect further includes one or more antenna terminals (5a, 5b), and an antenna switch (6). The antenna switch (6) is connected to a subsequent stage of the variable low pass filter (10) and to the one or more antenna terminals (5a, 5b). The variable low pass filter (10) includes a variable capacitor (C5). The variable capacitor (C5) changes depending on the communication band of the transmission signal outputted from the first output unit (78, 79). The variable capacitor (C5) is formed integrally with the antenna switch (6).

According to this configuration, it is possible to downsize the variable low pass filter (10).

The high frequency module (1) of a fifth aspect according to the fourth aspect further includes a multiband coupler (11). The multiband coupler (11) is provided on a transmission line (TL1) located between the variable low pass filter (10) and the antenna switch (6), and detects the transmission signal that passes through the transmission line (TL1). The multiband coupler (11) includes a sub-line (43), which is electromagnetically coupled to the transmission line (TL1) and has a changeable length. By changing the length of the sub-line (43) to a length corresponding to the communication band of the transmission signal, the multiband coupler (11) detects the aforementioned transmission signal.

According to this configuration, the use of the multiband coupler (11) enables the single coupler (the multiband coupler (11)) to detect the transmission signals in the multiple communication bands, and to control the output of the transmission signal accurately for each communication band.

The high frequency module (1) of a sixth aspect according to the fourth or fifth aspect further includes a high pass filter (12, 13). The high pass filter (12, 13) is connected between the antenna switch (6) and the antenna terminal (5a, 5b).

According to this configuration, an unnecessary low frequency component included in the transmission signal can be attenuated by using the high pass filter (12, 13).

The high frequency module (1) of a seventh aspect according to any one of the third to sixth aspects further includes an output matching circuit (9). The output matching circuit (9) is connected between the first output unit (78, 79) and the variable low pass filter (10). The final stage amplification unit (72) includes a first amplification unit (74) and a second amplification unit (75). Respective input units of the first amplification unit (74) and the second amplification unit (75) are connected to each other. The output matching circuit (9) includes a transformer (90). The transformer (90) includes a balanced side coil (91) and an unbalanced side coil (92). The balanced side coil (91) includes a first end (91a) and a second end (91b). The first end (91a) is connected to an output unit of the first amplification unit (74). The second end (91b) is connected to an output unit of the second amplification unit (75). The unbalanced side coil (92) includes a third end (92a) and a fourth end (92b). The third end (92a) is connected to an input unit of the variable low pass filter (10). The fourth end (92b) is connected to ground.

According to this configuration, in the case where the final stage amplification unit (72) is an amplifier of a differential type, it is possible to bring about similar effects to the effects of the first aspect.

The high frequency module (1) of an eighth aspect according to the seventh aspect includes one or more antenna terminals (5a, 5b), and an antenna switch (6). The antenna switch (6) is connected to a subsequent stage of the variable low pass filter (10) and to the one or more antenna terminals (5a, 5b). The output matching circuit (9) further includes multiple inductors (L1, L2) and multiple switches (SW1, SW2). The multiple inductors (L1, L2) are connected between a transmission line, which is located between the transformer (90) and the variable low pass filter (10), and ground and are connected in parallel with each other. The multiple switches (SW1, SW2) correspond to the multiple inductors (L1, L2), and each connect and disconnect the corresponding inductor (L1 or L2) to and from the ground depending on the communication band of the transmission signal outputted from the first output unit (78, 79). The multiple switches (SW1, SW2) are formed integrally with the antenna switch (6).

According to this configuration, the output matching circuit (9) can be downsized since the multiple switches (SW1, SW2) are formed integrally with the antenna switch (6). Meanwhile, since the multiple switches (SW1, SW2) are connected and disconnected depending on the communication band of the output signal from the variable low pass filter (10), the inductor of the output matching circuit (9) on the whole can be changed depending on the communication band of the output signal from the variable low pass filter (10). Thus, the output matching characteristics of the output matching circuit (9) can be changed depending on the communication band of the output signal from the first output unit (78, 79).

The high frequency module (1) of a ninth aspect according to the seventh or eighth aspect includes one or more antenna terminals (5a, 5b), and an antenna switch (6). The antenna switch (6) is connected to a subsequent stage of the variable low pass filter (10) and to the one or more antenna terminals (5a, 5b). The output matching circuit (9) further includes a variable capacitor (C4). The variable capacitor (C4) is connected between a transmission line, which is located between the transformer (90) and the variable low pass filter (10), and the ground. Capacitance of the variable capacitor is changed depending on the communication band of the transmission signal outputted from the first output unit (78, 79). The variable capacitor (C4) is formed integrally with the antenna switch (6).

According to this configuration, it is possible to downsize the output matching circuit (9) since the variable capacitor (C4) of the output matching circuit (9) is formed integrally with the antenna switch (6). Meanwhile, since the variable capacitor (C4) is changeable depending on the communication band of the output signal from the variable low pass filter (10), the output matching characteristics of the output matching circuit (9) can be changed depending on the communication band of the output signal from the variable low pass filter (10). In this way, the output matching characteristics of the output matching circuit (9) can be changed to an optimum value depending on the communication band of the output signal from the variable low pass filter (10).

In the high frequency module (1) of a tenth aspect according to any one of the first to ninth aspects, the first communication band is n77, and the second communication band is n79.

According to this configuration, it is possible to bring about similar effects to the effects of the first aspect in the case where the first communication band is n77 and the second communication band is n79.

A communication apparatus (200) of an eleventh aspect includes the high frequency module (1) according to any one of the first to tenth aspects, and a signal processing circuit (2). The signal processing circuit (2) is connected to the high frequency module (1) and performs signal processing of a high frequency signal.

According to this configuration, it is possible to provide the communication apparatus (200) that brings about the effects of the high frequency module (1).

What is claimed is:

1. A high frequency module comprising:
a first input to which a first transmission signal in a first communication band is inputted;
a second input to which a second transmission signal in a second communication band different from the first communication band is inputted;
a first output;
a first drive stage amplifier connected to a subsequent stage of the first input;
a second drive stage amplifier connected to a subsequent stage of the second input;
a final stage amplifier connected to a precedent stage of the first output;
a first filter type matching circuit connected between the first drive stage amplifier and the final stage amplifier, and having a first pass band including the first communication band and a first attenuation band including the second communication band; and
a second filter type matching circuit connected between the second drive stage amplifier and the final stage amplifier, and having a second pass band including the second communication band and a second attenuation band including the first communication band.

2. The high frequency module according to claim 1,
wherein a frequency band of the second communication band is higher than a frequency band of the first communication band,
wherein the first matching circuit is a low pass filter type matching circuit, and
wherein the second matching circuit is a high pass filter type matching circuit.

3. The high frequency module according to claim 1, further comprising:
a variable low pass filter connected to a subsequent stage of the first output,
wherein a pass band of the variable low pass filter is configured to change depending on a communication band of a transmission signal outputted from the first output.

4. The high frequency module according to claim 3, further comprising:
one or more antenna terminals; and
an antenna switch connected to a subsequent stage of the variable low pass filter, and to the one or more antenna terminals,
wherein the variable low pass filter comprises a variable capacitor configured to change depending on the communication band of the transmission signal outputted from the first output, and
wherein the variable capacitor is formed integrally with the antenna switch.

5. The high frequency module according to claim 4, further comprising:
a multiband coupler on a transmission line between the variable low pass filter and the antenna switch, and configured to detect the transmission signal that passes through the transmission line,
wherein the multiband coupler comprises a sub-line electromagnetically coupled to the transmission line and having a changeable length, and
wherein the multiband coupler is configured to detect the transmission signal by changing the length of the sub-line to a length corresponding to the communication band of the transmission signal.

6. The high frequency module according to claim 4, further comprising:
a high pass filter connected between the antenna switch and the one or more antenna terminals.

7. The high frequency module according to claim 3, further comprising:
an output matching circuit connected between the first output and the variable low pass filter,
wherein the final stage amplifier comprises a first amplifier and a second amplifier,
wherein respective inputs of the first amplifier and the second amplifier are connected to each other,
wherein the output matching circuit comprises a transformer, and
wherein the transformer comprises:
a balanced side coil having a first end connected to an output of the first amplifier, and a second end connected to an output of the second amplifier, and
an unbalanced side coil having a third end connected to an input of the variable low pass filter, and a fourth end connected to ground.

8. The high frequency module according to claim 7, comprising:
one or more antenna terminals; and
an antenna switch connected to a subsequent stage of the variable low pass filter, and to the one or more antenna terminals,
wherein the output matching circuit comprises:
a plurality of inductors connected in parallel with each other between a transmission line and ground, the transmission line being between the transformer and the variable low pass filter, and
a plurality of switches corresponding to the plurality of inductors, each of the plurality of switches being configured to connect and disconnect the corresponding inductor to and from the ground depending on the communication band of the transmission signal outputted from the first output, and
wherein the plurality of switches are formed integrally with the antenna switch.

9. The high frequency module according to claim 7, comprising:
one or more antenna terminals; and
an antenna switch connected to a subsequent stage of the variable low pass filter, and to the one or more antenna terminals,
wherein the output matching circuit further comprises a variable capacitor connected between a transmission line and ground, the transmission line being between the transformer and the variable low pass filter,
wherein a capacitance of the variable capacitor is configured to change depending on the communication band of the transmission signal outputted from the first output, and
wherein the variable capacitor is formed integrally with the antenna switch.

10. The high frequency module according to claim 1,
wherein the first communication band is n77, and
wherein the second communication band is n79.

11. A communication apparatus comprising:
the high frequency module according to claim 1; and
a signal processing circuit connected to the high frequency module and configured to perform signal processing of a high frequency signal.
